(19) United States
(12) Patent Application Publication
(10) Pub. No.: US 2013/0031380 A1
(43) Pub. Date: Jan. 31, 2013

(54) POWER SUPPLY CONVERTING SYSTEM AND METHOD

(71) Applicants: Ying-Bin FU, Shenzhen City (CN); Ting GE, Shenzhen City (CN); Ya-Jun PAN, Shenzhen City (CN)

(72) Inventors: Ying-Bin FU, Shenzhen City (CN); Ting GE, Shenzhen City (CN); Ya-Jun PAN, Shenzhen City (CN)

(73) Assignees: HON HAI PRECISION INDUSTRY CO., LTD., Tu-Cheng (TW); HONG FU JIN PRECISION INDUSTRY(Shenzhen) CO., LTD., Shenzhen City (CN)

(21) Appl. No.: 13/278,108

(22) Filed: Oct. 20, 2011

(30) Foreign Application Priority Data
Jul. 27, 2011 (CN) 201110211771.1

(51) Int. Cl. G06F 1/26

(52) U.S. Cl. 713/300

(57) ABSTRACT

A power supply converting system includes a start unit for outputting power to a server through a number of circuitries, an obtaining unit, a comparison unit, a memory module, and a converting unit. The obtaining unit is connected to the start unit and the server, to obtain the model code of a central processing unit (CPU) of the server and transmits the model code to the comparison unit. The comparison unit compares the model code of the server CPU against a plurality of circuitry codes in a truth table stored in the memory module, to obtain a circuitry code corresponding to the model code of the server CPU. The converting unit adjusts the numbers of turned on circuitries based on the circuitry code from the comparison unit.

### BACKGROUND

1. Technical Field

The present disclosure relates to a power supply converting system and a power supply converting method.

2. Description of Related Art

Usually, a server with a single central processing unit (CPU) can support several different types of CPUs with different power levels, such as 65 watts, 95 watts, and 130 watts. The power of the power supply are supplied to CPU through a plurality of circuitries which each circuitry has a pair of MOSFETs and inductors, and a Pulse Width Modulator (PWM) is used for controlling the pair of MOSFETs to turn on or turn off, and further controls the circuitry to turn on or turn off. The more the power requirement of the CPU, the greater number of circuitries which should be turned on. The 65 watt CPU needs the three circuitries to be turned on, the 90 watt CPU needs four circuitries to be turned on, and the 130 watt CPU needs five circuitries to be turned on. The maximum circuitries are turned on to transmit power of the power supply can support all types of CPUs, for example, the five circuitries supports the 65 watt CPU, 90 watt CPU, and 130 watt CPU. However, a low power CPU working from the maximum circuitries will waste power, for example, the inefficiency losses of the 65 watt CPU working from the five or four circuitries is greater than the power loss of the 65 watt CPU working from the three circuitries. A server is usually designed to support a maximum circuitries corresponding to the maximum power CPU, so a low power CPU working from the maximum circuitries would produce great loss.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a power supply converting system, wherein the power supply converting system includes a converting unit.

FIG. 2 is a block diagram of the converting unit of FIG. 1

FIG. 3 is a flow chart of an exemplary embodiment of a power supply converting method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

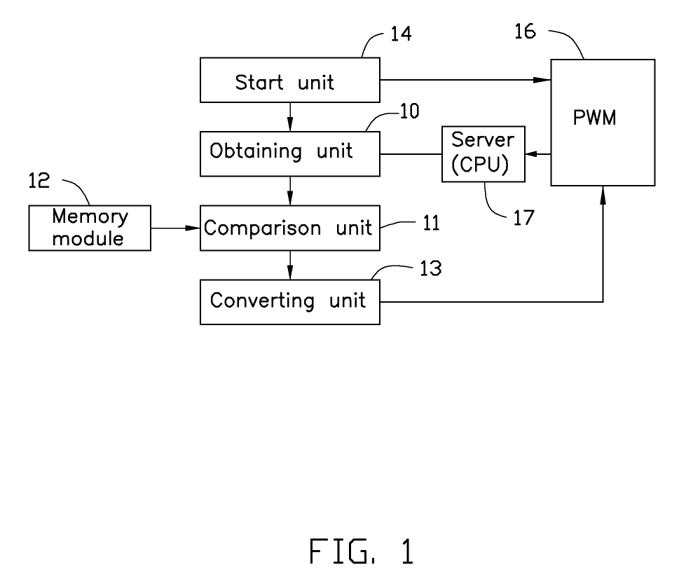

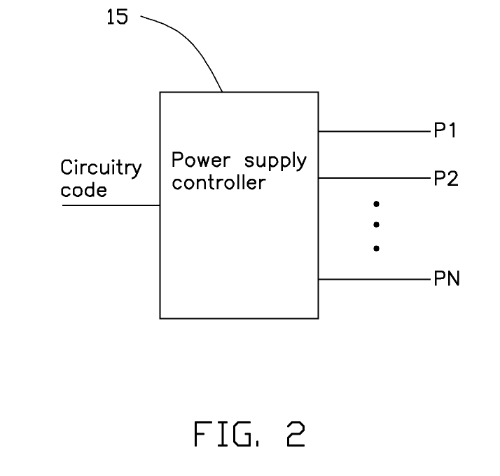

Referring to FIG. 1 and FIG. 2, an exemplary embodiment of a power supply converting system includes a start unit 14, an obtaining unit 10 connected to the start unit 14, a comparison unit 11 connected to the obtaining unit 10, a memory module 12 connected to the comparison unit 11, a converting unit 13 connected to the comparison unit 11, and a server 17 with a central processing unit (CPU) connected to the obtaining unit 10. A power supply 16 is connected to the start unit 14, the obtaining unit 10, the converting unit 13, and a plurality of circuitries P1, P2, PN for transmitting power from the power supply to CPU. When the start unit 14 is started, all circuitries are turned on to transmit power from the power supply to CPU. The server 17 is switched on. The obtaining unit 10 obtains a model code of the CPU of the server 17 to which the power supply 16 supplies power, and transmits the model code to the comparison unit 11. The memory module 12 contains a truth table which includes a plurality of model codes of different types of CPUs, and a plurality of power circuitry codes corresponding to the model codes. The comparison unit 11 compares the model code of the CPU of the server 17 from the obtaining unit 10 with the model codes in the truth table, and establishes the circuitry code corresponding to the model code of the CPU of the server 17. The circuitry code of the CPU of the server 17 is transmitted to the converting unit 13, and the converting unit 13 turns on numbers of the circuitries to transmit power.

The converting unit 13 in the embodiment is a power supply controller 15. The power supply controller 15 is used for controlling the numbers of the turned on circuitries based on the circuitry code from the comparison unit 11. In the figure, P stands for circuitry. N stands for the total number of the circuitries. If the circuitry code from the comparison unit 11 indicates a requirement for all circuitries to be turned on, the power supply controller 15 turns on all the circuitries P1-PN. If the circuitry code from the comparison unit 11 indicates a requirement for outputting the first to three circuitries, the power supply controller 15 turns on the circuitries P1-P3, and circuitries P4-PN are cut off.

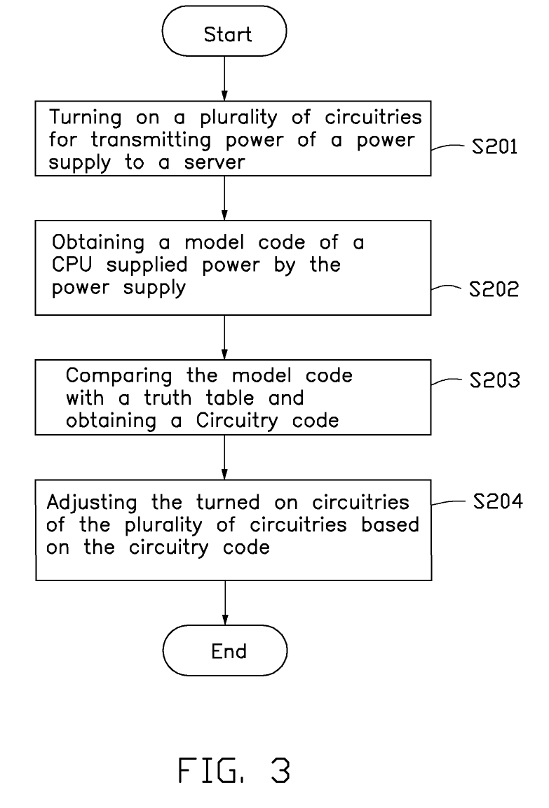

Referring to FIG. 3, an exemplary embodiment of a power supply converting method includes the following steps.

Step S201, the power supply 16 is started and supplying power to the central processing unit (CPU) of the server 17 through all circuitries.

Step S202, the model code of the CPU of the server 17 is obtained.

Step S203: the model code is looked up in a truth table to obtain a circuitry code corresponding to the model code.

The truth table includes two types of codes provided by the CPU manufacturer, the codes include a plurality of model codes corresponding to different types of CPUs and a plurality of circuitry codes corresponding to the model codes.

Step S204: the number of the turned on circuitries is adjusted by the power supply controller 15 if the circuitry code which is required does not equal the circuitries which is being output. For example, if the circuitry code stands for a three circuitries, the power supply controller 15 turns on three circuitries to transmit power.

It is to be understood, however, that even though numerous characteristics and advantages of the present disclosure have been set forth in the foregoing description, together with details of the structure and function of the disclosure, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A power supply converting system, comprising:
a start unit for starting a power supply to output power to a server through a plurality of circuitries;
an obtaining unit for obtaining a model code of a central processing unit (CPU) of the server;
a memory module storing a truth table which comprises a plurality of model codes of different types of CPUs and a plurality of circuitry codes corresponding to the model codes;
a comparison unit for comparing the model code of the CPU of the server with the truth table, and obtaining a circuitry code corresponding to model code; and
a converting unit for adjusting turned on circuitries of the plurality of circuitries based on the circuitry code from the comparison unit.

2. The power supply converting system of claim 1, wherein the converting unit is a power supply controller.

3. A power supply converting method, comprising:
starting a power supply to output power for a server through a plurality of circuitries;
obtaining a model code of a central processing unit (CPU) of the server;
comparing the model code with a truth table comprising a plurality of model codes of different types of CPUs and a plurality of circuitry codes corresponding to the model codes, to obtain a circuitry code corresponding to the model code of the CPU of the server; and
adjusting the turned on circuitries if the circuitry code does not equal to the working circuitries.

4. The power supply converting method of claim 3, wherein a power supply controller adjusts the numbers of the turned on circuitries based on the circuitry code.
